(19) United States
(12) Patent Application Publication
(10) Pub. No.: US 2006/0064730 A1
(43) Pub. Date: Mar. 23, 2006

(54) Configurable entertainment network

(76) Inventors: Jacob Rael, Los Angeles, CA (US); Henry Rael, Tijeras, NM (US)

Correspondence Address: GARLICK HARRISON & MARKISON LLP, P.O. BOX 160727, AUSTIN, TX, 78716-0727, US

(21) Appl. No.: 10/944,508

(22) Filed: Sep. 17, 2004

(51) Int. Cl. H04N 7/18; H04N 7/173

(52) U.S. Cl. 725/95; 725/74; 725/81

(57) ABSTRACT

A method for configuring an entertainment network begins by polling, by a master component of the entertainment network, slave components via a communication channel to identify active slave components of the entertainment network. The method continues by providing, by each of the active slave components, a profile response to the master component via the communication channel in response to the polling. The method continues by determining, by the master component, bandwidth requirements and configuration options of the entertainment network based on the profile responses of the active slave components and a profile of the master component. The method continues by, based on the bandwidth requirements and the configuration options of the entertainment network, establishing, by the master component, at least one of: a virtual connection between the master component and at least one of the active slave components and a virtual connection between a first one of the active slave components and a second one of the active slave components.

### BACKGROUND OF THE INVENTION

1. Technical Field of the Invention

This invention relates generally to entertainment systems and more particularly to network-based configurability of such entertainment systems.

2. Description of Related Art

As is known, entertainment systems have evolved from a television set and a radio to complex systems that include expensive video equipment, computers, satellite receivers, cable receivers, broadcast receivers, expansive audio equipment, video game equipment, DVD players, CD players, etc. Such complex entertainment systems offer its users tremendous variety in home entertainment and movie theater quality.

As is also known, providing the electrical coupling between the components of an entertainment system is done through direct connect wiring. For example, a receiver is typically direct wire coupled to a DVD player, a VCR, a cable set top box, speakers, and a video monitor. Such direct wire coupling includes a significant number of wires that most users desire to hide either in the wall or behind the furniture supporting the equipment.

Typically, once an entertainment system is set-up via direct wire coupling, adding or removing components from the system is a rather involved task. For instance, assume that the user desires to add a satellite receiver to the above mentioned system. In this instance, the user would direct wire couple the satellite receiver to the system receiver, which may or may not have inputs to accommodate the satellite receiver and will require a physical manipulation of the existing direct wire coupling. Once the satellite receiver is wired in, the even larger number of wires would again need to be hidden in the wall and/or behind the furniture. Similar issues arise when a component is removed from the system.

Further, as the entertainment system is being set-up, decisions are made as to which inputs and outputs of the equipment to use. For instance, a system receiver may include composite, S-video, RGB (Red, Green, Blue for computer-type monitors), and/or YCrCb (progressive scan video) video inputs and outputs. Once the decision as to which inputs and outputs to use have been implemented, it is requires a re-wiring of the system to change.

In an effort to reduce the number of wires in an entertainment system, wireless speakers have been created. Such wireless speakers include a radio frequency (RF) receiver (typically in the 900 MHz band) that receives RF signals from the system receiver, which includes an RF transmitter. In general, the transmitter of the system receiver modulates the audio signals that are destined for the speakers on an RF carrier to produce the RF signals. The RF receiver of the speakers receives the RF signals and demodulates them to recapture the original audio signals.

While wireless speakers reduce the number of direct wire connections in an entertainment system, such systems are still primarily direct wire coupled. As such, changes to the system require a relatively significant effort.

Therefore, a need exists for a user-friendly method and apparatus of configuring and/or reconfiguring an entertainment system.

### BRIEF SUMMARY OF THE INVENTION

The configurable entertainment network of the present invention substantially meets these needs and others. In one embodiment, a method for configuring an entertainment network begins by polling, by a master component of the entertainment network, slave components via a communication channel to identify active slave components of the entertainment network. The method continues by providing, by each of the active slave components, a profile response to the master component via the communication channel in response to the polling. The method continues by determining, by the master component, bandwidth requirements and configuration options of the entertainment network based on the profile responses of the active slave components and a profile of the master component. The method continues by, based on the bandwidth requirements and the configuration options of the entertainment network, establishing, by the master component, at least one of: a virtual connection between the master component and at least one of the active slave components and a virtual connection between a first one of the active slave components and a second one of the active slave components.

In another embodiment, a method for network-type communications within an entertainment network begins by sensing, by a master component of the entertainment network, activation of one of a plurality of components of the entertainment network, wherein the plurality of components includes the master component and slave components. The method continues by determining, by the master component, configuration requirements for the one of the plurality of components. The method continues by providing, by the master component, an enable signal to another one of the plurality of components when the configuration requirements include interfacing with the another one of the plurality of components. The method continues by assigning, by the master component, at least one channel to support network-type communications involving the one of the plurality of components. The method continues by allocating, by the master component, bandwidth of the at least one channel to the one of the plurality of components for up-stream communications.

In yet another embodiment, a method for configuring an entertainment network begins by placing the entertainment network in a configuration mode. The method continues by providing a user interface within the entertainment network to receive user configuration commands. The method continues by interpreting, by a master component of the entertainment network, the user configuration commands to determine desired connections within the entertainment network. The method continues by determining, by the master component, bandwidth requirements for each of the desired connections. The method continues by, based on the bandwidth requirements for each of the desired connections, establishing, by the master component, at least one of: a virtual connection between the master component and one of a plurality of slave components of the entertainment network and a virtual connection between a first one of the plurality of slave components and a second one of the plurality of slave components.

### BRIEF DESCRIPTION OF THE SEVERAL VIEWS OF THE DRAWINGS

FIG. 1 is a schematic block diagram of a wireless entertainment network in accordance with the present invention;

FIG. 2 is a schematic block diagram of a wired entertainment network in accordance with the present invention;

FIG. 3 is a schematic block diagram of a wired and wireless entertainment network in accordance with the present invention;

FIG. 4 is a diagram of an example profile table in accordance with the present invention;

FIG. 5 is a diagram of example virtual connections within a wireless entertainment network in accordance with the present invention;

FIG. 6 is a diagram of an example of a virtual connection map in accordance with the present invention;

FIG. 7 is an example of communications within an entertainment network in accordance with the present invention; and

FIG. 8 is a schematic block diagram of another entertainment network in accordance with the present invention.

### DETAILED DESCRIPTION OF THE INVENTION

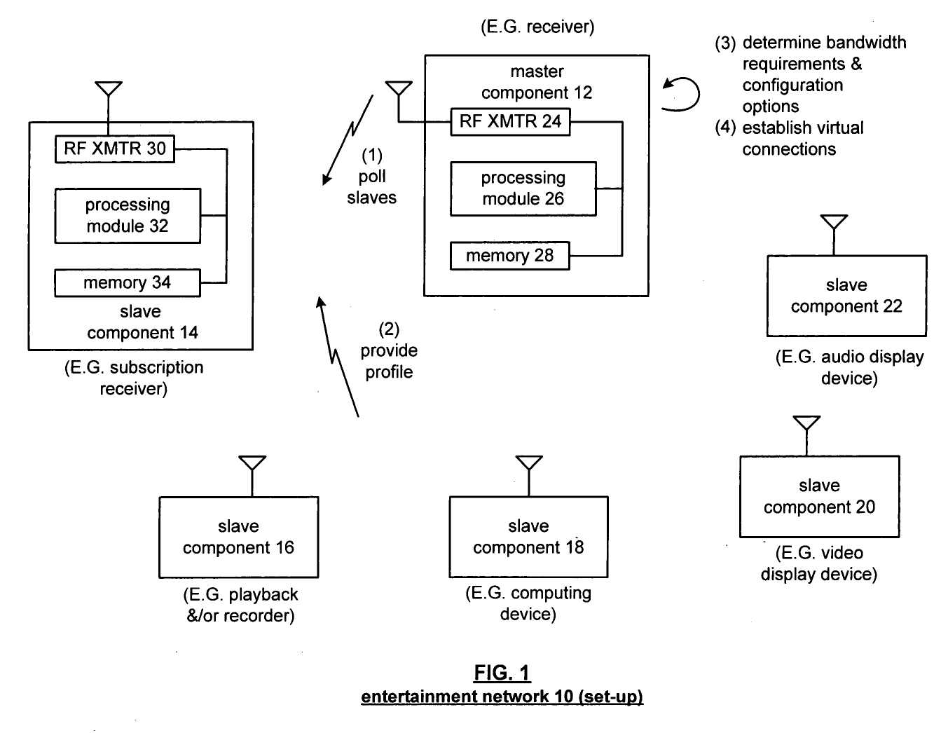

FIG. 1 is a schematic block diagram of a wireless entertainment network 10 during setup. The entertainment network 10 includes a master component 12 and a plurality of slave components 14-22. The master component 12 includes a radio frequency (RF) transmitter (XMTR) 24, a processing module 26, and memory 28. Slave component 14, which is representative of the other slave components 16-22, includes a radio frequency transmitter 30, processing module 32, and memory 34. The RF transmitters 24 and 30 may be in accordance with one or more wireless communication standards. For example, the RF transmitters 24 and 30 may be constructed in accordance with one or more versions of the Bluetooth standard, one or more versions of IEEE 802.11, et cetera.

The processing modules 26 and 32 may each be individual processing devices and/or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory 28 and 34 may be a single memory device or a plurality of memory devices. Such a memory device may be a read-only memory, random access memory, volatile memory, non-volatile memory, static memory, dynamic memory, flash memory, cache memory, and/or any device that stores digital information. Note that when the processing module 26 or 32 implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry. The memory 28 and/or 34 stores, and the processing module 26 and/or 32 executes, operational instructions corresponding to at least some of the functions illustrated in FIGS. 1-8.

To facilitate the setup of the wireless entertainment network 10 one or more of the components is designated as a master component. In this example, component 12 is designated as the master. For example, a system receiver may be designated as a master component, while a subscription receiver (e.g., cable set-top box, satellite receiver, broadcast receiver, playback and/or recorder device), CD player, DVD player, VCR, video disk, computing device (e.g., personal computer, laptop, personal digital assistant), video display device (e.g., Cathode ray tube (CRT), LCD monitor, TV monitor, video projector), and audio display device (e.g., speakers, headphones) may be chosen as slave components. If more than one component is selected as the master component, the master components would distribute the master functionality.

The setup of a wireless entertainment network 10 begins when the master component 12 polls the slave components via a wireless channel to identify the active slave components within the network. For instance, slave component 14 may be off such that it is not actively within the network. Note that the polling may be done in accordance with a wireless communication standard, e.g., one or more versions of Bluetooth. Further, the polling may be done by obtaining a system identification code for each of the slave components and addressing the slave components by the system identification code. The user of the system may assign the system identification codes via a user input of the entertainment network or the components may establish individual system identification codes via an auto-negotiation.

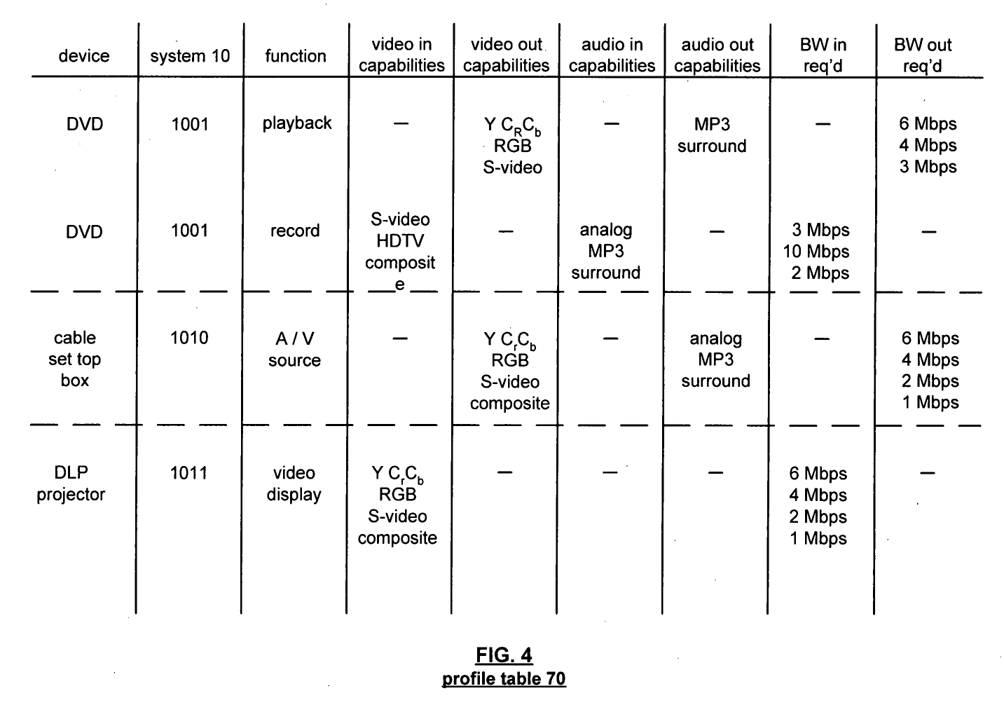

Upon receiving the poll request, each of the active slave components provides a profile response to the master component via the wireless communication channel. In general, the profile includes the device type, video input/output capabilities, audio input/output capabilities, functions, and per-function capabilities. The profile will be described in greater detail with the example of FIG. 4.

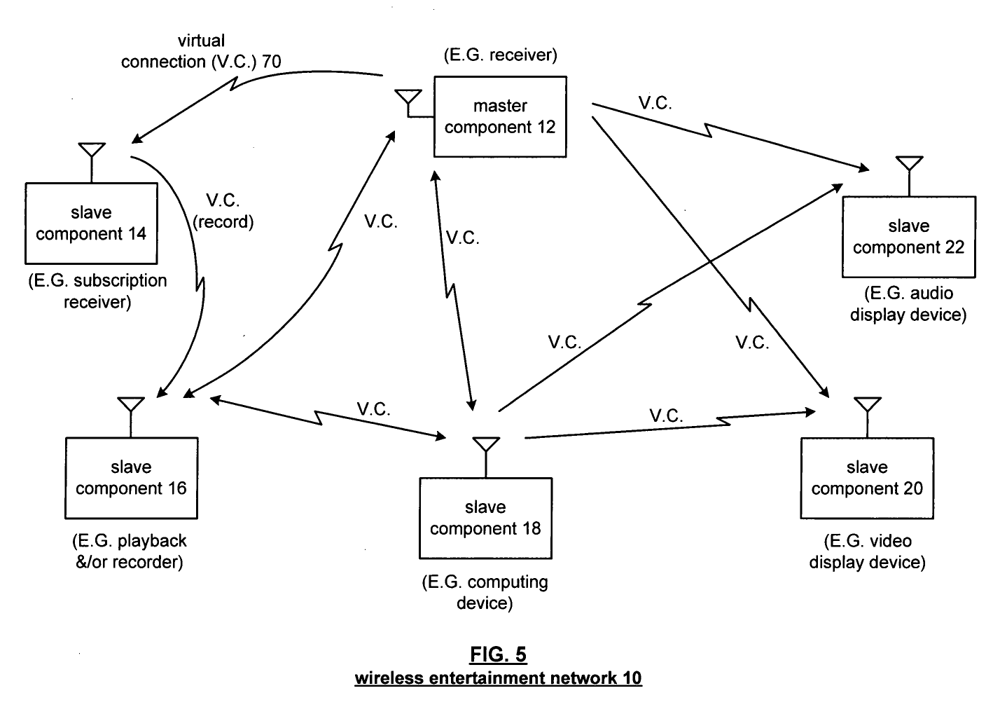

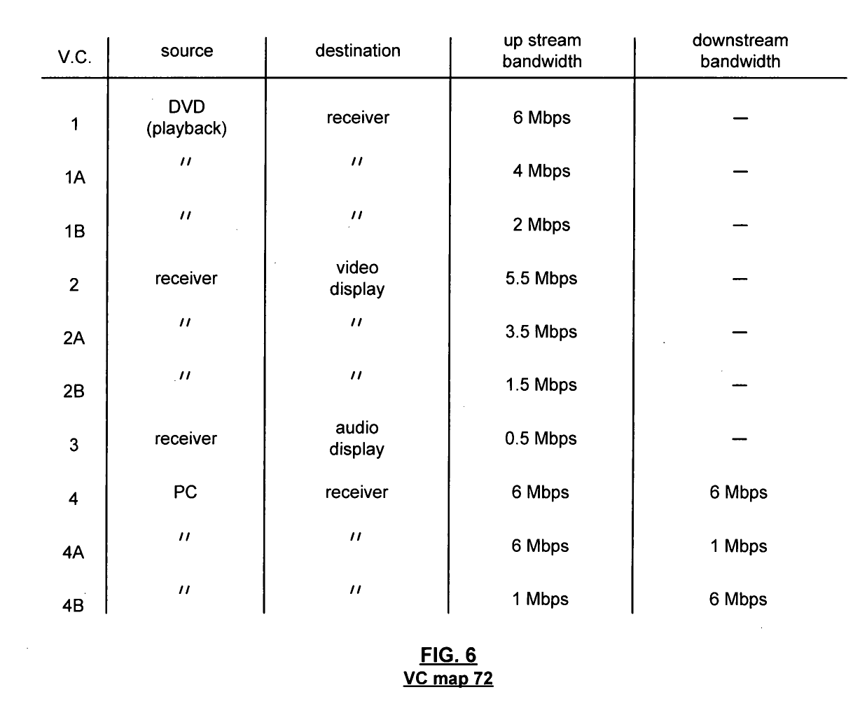

Upon receiving the profile responses from the active slaves, the master component 12 determines bandwidth requirements and configuration options for each of the slave devices. For example, slave component 16 may be a DVD player, which has composite, S-video and YCrCb video inputs and outputs. Each one of these video inputs and outputs may provide a different configuration option as well as having different bandwidth requirements. The DVD player, for example, may have connectivity to the master component 12, which may be the system receiver, to a computing device, and/or to the audio and video display devices. A determination of the bandwidth and configuration options will be described in greater detail with the examples of FIGS. 5 and 6.

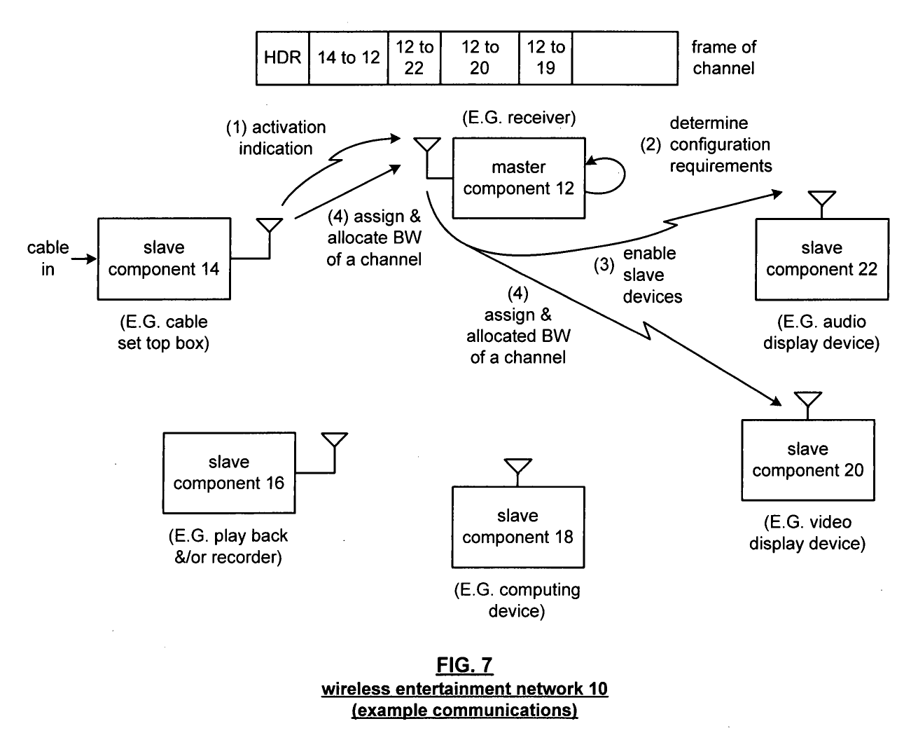

Having determined the bandwidth requirements and configuration options, the master component establishes virtual connections in accordance with the configuration options and corresponding bandwidth requirements. The virtual connections are based on possible desired communications at the appropriate bandwidths from one component within network 10 to another. As such, the virtual connections may be between the slave components, from a slave component to a master component and/or from a single component to multiple components. The virtual connections will be described in greater detail with the examples of FIGS. 5 and 6. As one of ordinary skill in the art will appreciate, the setup of the entertainment network 10 includes establishing a virtual connection map that indicates possible wireless connections between the components 12-22 of the network. The particular connections made will depend on user inputs as to how the network 10 will be utilized, which will be described in greater detail with reference to FIG. 7. As one of ordinary skill in the art will further appreciate, the wireless entertainment network 10 may use one or more wireless communication channels of one or more wireless standards. For example, one or more channels of the Bluetooth standard may be utilized, or versions thereof, and/or one or more channels of the IEEE 802.11 standards, or versions thereof, may be used.

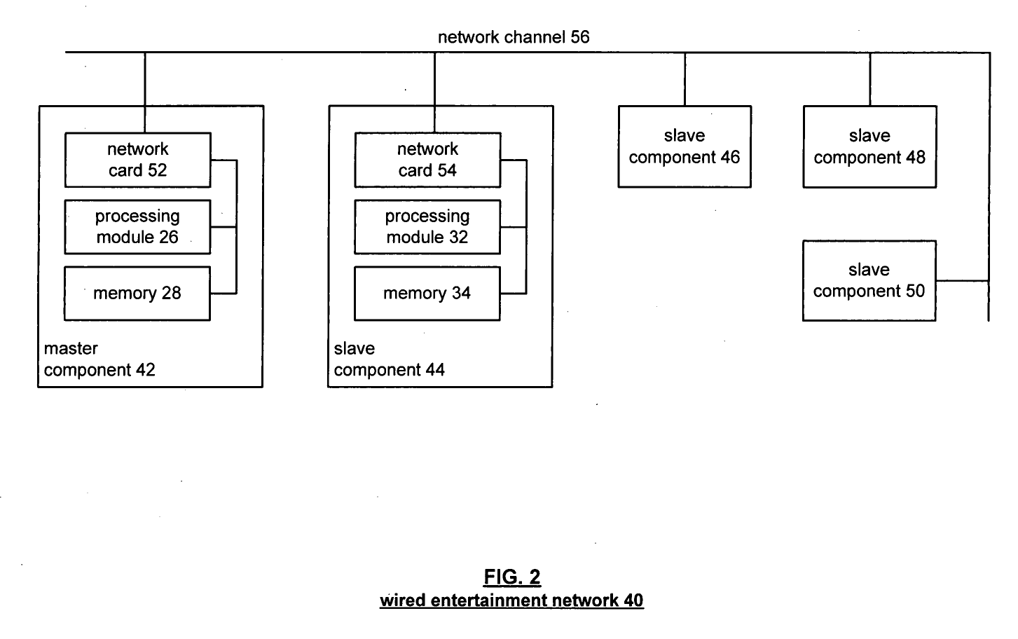

FIG. 2 is a schematic block diagram of a wired entertainment network 40 that includes a master component 42 and slave components 44-50. The master component 42 includes a network card 52, processing module 26 and memory 28. The slave component 44, which is representative of the other slave components 46-50, includes a network card 54, processing module 32 and memory 34.

The network cards 52 and 54 provide the components 42-50 with connectivity to a network channel 56. The network channel 56 may be an Ethernet connection, fire wire connection, and/or a standardized wire network protocol channel. The network cards 52 and 54 will function in accordance with the particular wired standard supported by the network channel 56.

The master component 42 establishes virtual connections between itself and the slave components 44-50 as previously described with reference to FIG. 1. In this embodiment, the communication path is via the network channel 56 as opposed to a wireless communication channel of FIG. 1. The establishment of the virtual channels and functionality of the entertainment network 40 will be described in greater detail with reference to FIGS. 4-7.

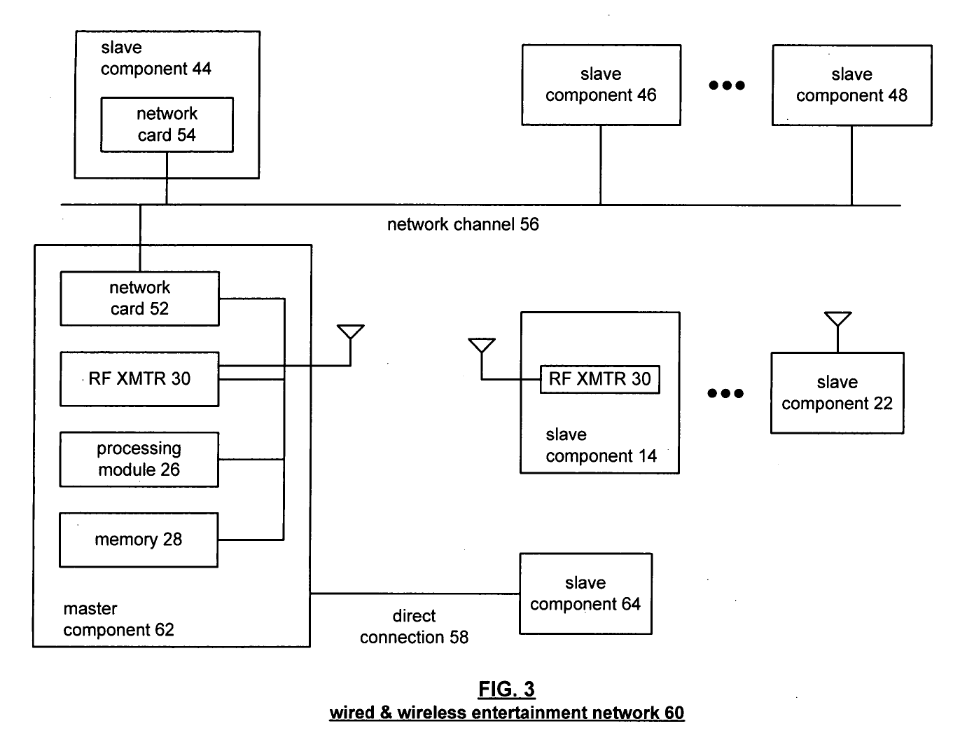

FIG. 3 is a schematic block diagram of a wired and wireless entertainment network 60. In this embodiment, the entertainment network 60 includes master component 62, wired slave components 44-48, wireless slave components 14-22 and a direct connect slave component 64. The master component 62 includes the network card 52, the RF transmitter 30, the processing module 26, and the memory 28. The wired slave components 44-48 each include a network card 54 and are coupled to a network channel 56. Each of the wireless slave components 14-22 includes a radio frequency transmitter 30.

The setup of this network entertainment 60 includes a direct connection 58 between slave component 64 and master component 62. Virtual connections via the wired communication channel 56 may be established as previously described with reference to FIGS. 1 and 2. The virtual connections via the wireless communication channel, or channels, may be established as previously described with reference to FIG. 1.

As one of ordinary skill in the art will appreciate, by providing wired and/or wireless network connectivity between the components of an entertainment system, the entertainment system may be readily configured and re-configured without the hassles of rewiring direct connections. For example, if the composite video output of a DVD player is used and the user desires to change that to an S-video output, a change in the selected virtual connection from composite video-out to S-video out is made via the master component and the system is correspondingly reconfigured.

FIG. 4 is an example of a profile table 70. The table includes a plurality of fields, for example, device type, system identification code (ID), function, video-in capabilities, video-out capabilities, audio-in capabilities, audio-out capabilities, bandwidth input requirements and bandwidth output requirements. In this example, a DVD player is assigned system ID 1001 and has two functions; playback and record. In the playback mode, the DVD player has only output requirements. For example, the video output capabilities may be S-video, RGB, and/or YCRCB. The audio-output capabilities may be MP3 and/or surround sound. Each of these output configurations has a different bandwidth requirement. For example, the playback of a DVD may require 6 megabits-per-second, 4 megabits-per-second, 3 megabits-per-second, et cetera. From this information, the master component may setup one or more virtual connections for each possible video-output and audio-output configuration. As such, based on this example, the DVD player in playback mode may have 6 virtual output connections to each of one or more components in the system.

In a record mode, the DVD player has only input requirements. As shown, the video-input capabilities may include S-video, HDTV, composite video and the audio-inputs may include analog, MP3 and/or surround sound. Each of these different input requirements has different bandwidth requirements. For example, 3 megabits-per-second, 10 megabits-per-second, 2 megabits-per-second, et cetera. Based on this information, the master component may establish up to 9 virtual input connections for the DVD player in the record mode from each of the devices within the network that could provide inputs to the DVD player for recording.

As is further shown in the profile table 70, a cable set-top box may be assigned system ID 1010 and have an audio/video source function. While, with respect to the network, the cable set-top box does not have an audio or video input capabilities, such connectivity comes directly from a cable connection, it does have video and audio output capabilities. For example, the set-top box may have video-output selections of composite video, S-video, RGB video, and/or YCrCb video. As is also shown, the audio-output capabilities may be analog, MP3 and/or surround sound. Based on the various combinations of the video-outputs and audio-outputs, the bandwidth output requirements may change. For example, the bandwidth requirements may range from 1 megabit-per-second to 6 megabits-per-second. Based on this information, the master component may setup multiple virtual output connections from the set-top box to one or more of the components of the entertainment network that can either store and/or display the outputs from the set-top box.

The profile table 70 also includes a DLP projector device, which is assigned system ID 1011 and has the function of video display. The DLP projector only includes video-input capabilities of, for example, composite video, S-video, RGB video, and/or YCrCb video. Each of these types of video-inputs has a different bandwidth requirement. For example, the bandwidth may range from 1 megabit-per-second to 6 or more megabits-per-second.

As one of ordinary skill in the art will appreciate, the profile table 70 may be stored within memory 28 of the master component and/or stored in the memory of one or more of the slave components. As one of ordinary skill in the art will further appreciate, other devices may be included in the profile table and the video-input and output capabilities, audio-input and output capabilities and bandwidth input and output requirements may vary from the examples shown in FIG. 4.

FIG. 5 is an example of the master component 12 establishing virtual connections within the wireless entertainment network 10. The same concepts of establishing virtual connections are applicable to the systems of FIGS. 2 and 3. In this example, based on the profile table 70, the master component 12 establishes various virtual connections between the slave components and itself and between the slave components.

For example, if slave component 14 is a subscription receiver, a virtual connection 70 may be established between slave component 14 and master component 12, and another virtual connection for recording the data provided by the slave component 14 may be established with slave component 16. Other virtual connections may be established as shown. Further, multiple virtual connections may be established between the components based on the different audio and/or video capabilities of the components in the network. For example, if slave component 14 includes S-video and composite video outputs only, and slave component 16 includes composite video inputs, S-video inputs, RGB video inputs, YCRCB video inputs, the master component would establish 2 virtual connections between slave components 14 and 16; one for composite video and another for S-video.

As the master establishes the virtual connection, it generates a virtual connection map 72 as shown in FIG. 6. In the example of FIG. 6, the master generates numbered virtual connections that provide virtual connectivity between a source (e.g., output device) and destination (e.g., input device) and further indicate the desired upstream and downstream bandwidths. For reference, an upstream communication is from the source to the destination and a downstream communication is from the destination to the source.

In this example, three virtual connections are established between the DVD player, in the playback mode, and the system receiver. Each of the virtual connections has a different upstream bandwidth requirement based on the corresponding video inputs and outputs of the DVD player and receiver.

The map also includes multiple virtual connections between the system receiver and the video display device and corresponding differing upstream bandwidth requirements. In this example, a single virtual connection is made between the receiver and the audio display with a single upstream bandwidth requirement.

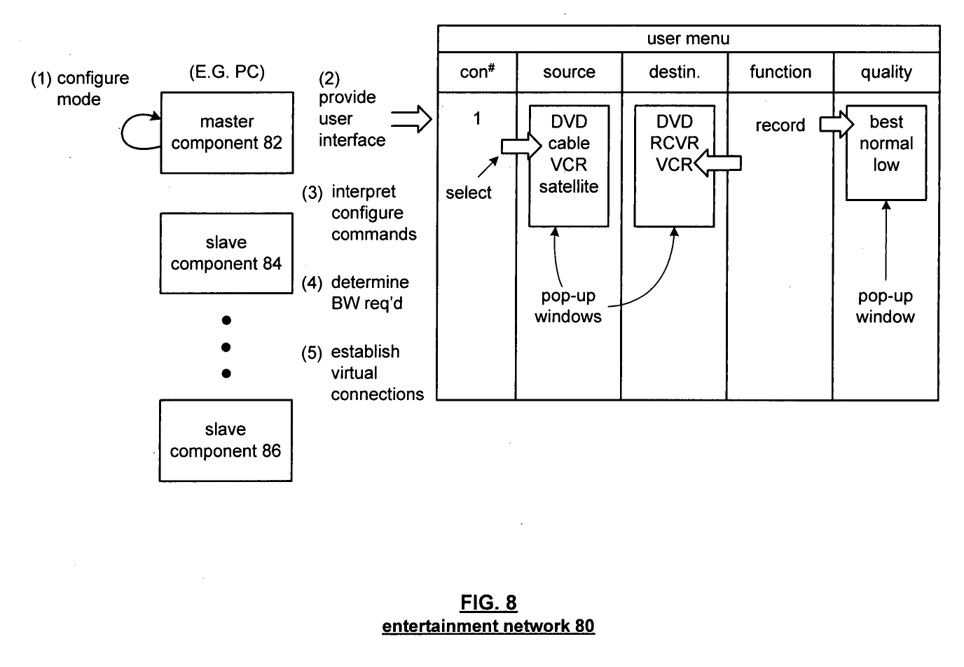

The example of the virtual connection map 72 further shows multiple virtual connections between a personal computer and the system receiver each having different upstream and downstream bandwidth requirements. As one of ordinary skill in the art will appreciate, the virtual connection map 72 may include up to all possible connections between the components within the network 10 and may be adjusted as components are activated or deactivated, and/or as components are added or removed from the network. Alternatively, the virtual connection map 72 may include the user defined virtual connections as will be described in greater detail with reference to FIG. 8.

FIG. 7 is a schematic block diagram of example communications within the wireless entertainment network 10. While FIG. 7 is directed towards the wireless entertainment network 10, the example communications described herein are applicable to the communications that occur within the networks of FIGS. 2 and 3.

In this example, the user has selected to view a channel from the cable set-top box. When the cable set-top box is activated, it sends an indication of its activation to the master component 12 via the wireless communication channel. Upon receiving the activation indication, the master component 12 determines the configuration requirements for the particular slave component selected. This may be done by interpreting the activation signal which includes the particular types of connectivity required and/or utilizing a default setting from the virtual map table. Note, that if the desired bandwidth for the communications is not available, the master may reduce the bandwidth requirements thus, lowering the quality of the audio and/or video but providing the desired service.

Having determined the configuration requirements, the master component then enables the corresponding slave components via the wireless communication channel. In this example, the master component enables the audio display device and the video display device. The master component 12 then assigns one or more wireless communication channels to support the selective cable set-top box and allocates the appropriate bandwidth of the one or more channels. Once the channel and bandwidth have been allocated, the slave component 14 provides audio and video outputs to the master component via a wireless communication channel. The master component 12 relays the audio and video to the audio and video display devices 20 and 22.

FIG. 7 further illustrates a frame of a wireless channel in accordance with the example of FIG. 7. As shown, the frame includes a header portion (HDR) and a data portion. The data portion bandwidth is divided into multiple sections. The 1^{st} section 14-12 indicates the bandwidth of a particular frame on a channel as being allocation for data to be conveyed from slave cable set top-box 14 to the master system receiver 12. The next section is indicated by 12-22, which is the bandwidth allocated for the master component 12 to provide audio signals to slave component 22. The next section of the data portion is labeled as 12-20, which indicates the bandwidth allocated per-frame-per-channel to the master component 12 providing video signals to slave component 20. The frame also includes a bandwidth allocation for data being relayed from the master component 12 to slave component 14. This section is labeled as 12-14.

This wireless configuration will remain as long as the slave component 14 is activated by the user for displaying audio and video. If the user changes the particular components for example, desires to watch a DVD via slave component 16, the process would first deactivate the channel and bandwidth allocations to the current setup and begin the process of reassigning the channel and bandwidth to the newly selective slave component 16.

FIG. 8 is a schematic block diagram of entertainment network 80 that may be a wireless network, wired network and/or combination thereof. In this illustration, the entertainment network 80 includes a master component 82 and a plurality of slave components 84-86. The master component 82 may be a similar component as master component 12, 42 and/or 62 while the slave components may be similar to slave component 14, 44 and/or 64. In this example, the entertainment network 80 is setup by having the master component 82, which may be a personal computer, place the network 80 in a configuration mode. In the configuration mode, which may be activated via a user input via the personal computer and/or other device within the network 80, provides a user interface on the master component 82 or on a display device within the network.

The user interface may be as shown in the accompanying example of a user menu. The user menu includes fields for connection number, source selection, destination selection function of the particular device and desired quality for the particular connection. In this example, a 1^{st} connection may be established between a source and a destination each of which may be selected via popup windows. In this example, the sources may be selected from a DVD player, cable set-top box, VCR, or satellite receiver. The destinations may be a DVD player, system receiver and/or VCR. In this example, the cable set-top box is selected as the source and the VCR is selected as the destination. The user may then select the particular function of the source and destination, or the function may be automatically determined based on the source and destination. The user may then decide the audio and/or video quality desired. In this example, a popup window is provided to indicate best quality, normal quality or low quality. In this example, the user has selected the best quality. The user then would go from component-to-component to establish as many virtual connections within the network as desired.

The master component interprets the configuration commands as selected by the user via the user menu to determine bandwidth requirements and configuration options. Having determined the bandwidth requirements, which is based on the source, destination function and quality selected, the master component establishes virtual connections. The virtual connections may be established via wireless communication channels and/or wired communication channels. The master component stores the virtual connections in a virtual connection map as previously described with reference to FIG. 6. Having generated the virtual connection map, the entertainment network 80 may be utilized as previously described with reference to FIG. 7.

As one of ordinary skill in the art will appreciate, the term “substantially” or “approximately”, as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items ranges from a difference of a few percent to magnitude differences. As one of ordinary skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled”. As one of ordinary skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The preceding discussion has presented a method and apparatus for configuring an entertainment system. By providing network type connectivity, the entertainment system may be readily reconfigured by removing components, adding components and/or changing desired video and/or audio inputs and outputs. As one of ordinary skill in the art will appreciate, other embodiments may be derived from the teaching of the present invention without deviating from the scope of the claims.

What is claimed is:

1. A method for configuring an entertainment network, the method comprises:
polling, by a master component of the entertainment network, slave components via a communication channel to identify active slave components of the entertainment network;
providing, by each of the active slave components, a profile response to the master component via the communication channel in response to the polling;
determining, by the master component, bandwidth requirements and configuration options of the entertainment network based on the profile responses of the active slave components and a profile of the master component; and
based on the bandwidth requirements and the configuration options of the entertainment network, establishing, by the master component, at least one of:
a virtual connection between the master component and at least one of the active slave components; and
a virtual connection between a first one of the active slave components and a second one of the active slave components.

2. The method of claim 1, wherein the polling of the slave components comprises:
polling the slave components based on an individual system identification code of each of the slave components.

3. The method of claim 2 further comprises:
obtaining a system identification code from a user input of the entertainment network; and
establishing the individual system identification codes of each of the slave components by at least one of:
auto-negotiating for the individual system identification codes by the slave components; and
obtaining the individual system identification codes of the slave components from the user input.

4. The method of claim 1, wherein the profile response comprises at least one of:
device type;
video input/output capabilities;
audio input/output capabilities;
functions; and
per function capabilities.

5. The method of claim 1 further comprises:
generating, by the master component, a virtual connection map that includes each of the virtual connections; and
providing the virtual connection map to the active slave components via the communication channel.

6. The method of claim 1 further comprises:
establishing, by the master component, a plurality of virtual connections from an input component to multiple output components, wherein the input component is the master component or one of the active slave components.

7. The method of claim 6, wherein the input component comprises at least one of:
a computer device;
a playback device; and
a receiver device.

8. The method of claim 6, wherein the output components comprises at least one of:
a video display device;
an audio display device; and
a recording device.

9. The method of claim 1 further comprises:
the channel including at least one of a wired communication channel and a wireless communication channel; and
each of the virtual connections including at least one of the wired communication channel and the wireless communication channel.

10. The method of claim 9 further comprises:
the wired communication channel including at least one of an Ethernet channel, a fire wire channel, and a standardized wired network protocol channel; and
the wireless communication channel including at least one of a Bluetooth wireless channel, an IEEE 802.11x wireless communication channel and a standardized wireless network protocol channel.

11. A method for network-type communications within an entertainment network, the method comprises:
sensing, by a master component of the entertainment network, activation of one of a plurality of components of the entertainment network, wherein the plurality of components includes the master component and slave components;
determining, by the master component, configuration requirements for the one of the plurality of components;
providing, by the master component, an enable signal to another one of the plurality of components when the configuration requirements include interfacing with the another one of the plurality of components;
assigning, by the master component, at least one channel to support network-type communications involving the one of the plurality of components; and
allocating, by the master component, bandwidth of the at least one channel to the one of the plurality of components for up-stream communications.

12. The method of claim 11 further comprises:
allocating, by the master component, additional bandwidth of the at least one channel to the another one of the plurality of components for down-stream communications.

13. The method of claim 11, wherein the sensing the activation comprises:
receiving, by the one of the plurality of components, a user input; and
providing, by the one of the plurality of components, an activation signal to the master component, wherein the activation signal indicates at least one function to be performed by the one of the plurality of components.

14. The method of claim 13, wherein the determining configuration requirements comprises:
interpreting the activation signal to identify the another one of the plurality of components and to determine bandwidth requirements.

15. The method of claim 14, wherein the determining configuration requirements further comprises:
accessing configuration preferences table for the one of the plurality of components to determine configuration preferences;
accessing a virtual connection map based on the configuration preferences to determine virtual connections; and
determining number of channels to be established and the bandwidth requirements of each of the wireless channels based on virtual connections and the configuration preferences.

16. The method of claim 15 further comprises:
the channel including at least one of a wired communication channel and a wireless communication channel; and
each of the virtual connections including at least one of the wired communication channel and the wireless communication channel.

17. The method of claim 16 further comprises:
the wired communication channel including at least one of an Ethernet channel, a fire wire channel, and a standardized wired network protocol channel; and
the wireless communication channel including at least one of a Bluetooth wireless channel, an IEEE 802.11x wireless communication channel and a standardized wireless network protocol channel.

18. A method for configuring an entertainment network, the method comprises:
placing the entertainment network in a configuration mode;
providing a user interface within the entertainment network to receive user configuration commands;
interpreting, by a master component of the entertainment network, the user configuration commands to determine desired connections within the entertainment network;
determining, by the master component, bandwidth requirements for each of the desired connections; and
based on the bandwidth requirements for each of the desired connections, establishing, by the master component, at least one of:
a virtual connection between the master component and one of a plurality of slave components of the entertainment network; and
a virtual connection between a first one of the plurality of slave components and a second one of the plurality of slave components.

19. The method of claim 18 further comprises:
monitoring, by the master component, operational status of the plurality of slave components for an operational change.

20. The method of claim 18, wherein the providing the user interface comprises at least one of:
providing a list of input components of the entertainment network;
providing a list of output components of the entertainment network;
detecting desired connections of one of the input components to at least one of the output components to establish a selected connection; and
detecting desired function of the selected connection to produce a selected function.

21. The method of claim 20, wherein the determining the bandwidth requirements comprises:
determining the bandwidth requirements for the selected connection based on the selected function.

22. The method of claim 18 further comprises:
each of the virtual connections including at least one of the wired communication channel and the wireless communication channel.

23. The method of claim 22 further comprises:
the wired communication channel including at least one of an Ethernet channel, a fire wire channel, and a standardized wired network protocol channel; and
the wireless communication channel including at least one of a Bluetooth wireless channel, an IEEE 802.11x wireless communication channel and a standardized wireless network protocol channel.

24. An entertainment network comprises:
a master component that includes a master processing module and master memory; and
a plurality of slave components, wherein each of the plurality of slave components includes a slave processing module and slave memory, wherein the master memory and the slave memory store operational instructions that cause the master processing module and the slave processing module to, respectively, enable the master component and the plurality of slave components to:
poll, by the master component, the plurality of slave components via a communication channel to identify active slave components;
provide, by each of the active slave components, a profile response to the master component via the communication channel in response to the polling;
determine, by the master component, bandwidth requirements and configuration options of the entertainment network based on the profile responses of the active slave components and a profile of the master component; and
based on the bandwidth requirements and the configuration options of the entertainment network, establish, by the master component, at least one of:
a virtual connection between the master component and at least one of the active slave components; and
a virtual connection between a first one of the active slave components and a second one of the active slave components.

25. The entertainment network of claim 24, wherein the master memory further store operational instructions that cause the master processing module to enable the master component to poll of the plurality of slave components:
polling the plurality of slave components based on an individual system identification code of each of the plurality of slave components.

26. The entertainment network of claim 25, wherein at least one of the master memory and the slave memory further store operational instructions that cause the master processing module and slave processing module to enable the master component and each of the plurality of slave components, respectively, to:
obtain a system identification code from a user input of the entertainment network; and
establish the individual system identification codes of each of the plurality slave components by at least one of:
auto-negotiating for the individual system identification codes by the slave components; and
obtaining the individual system identification codes of the slave components from the user input.

27. The entertainment network of claim 24, wherein the master memory further store operational instructions that cause the master processing module to enable the master component to:
generate a virtual connection map that includes each of the virtual connections; and
provide the virtual connection map to the active slave components via the communication channel.

28. The entertainment network of claim 24, wherein the master memory further store operational instructions that cause the master processing module to enable the master component to:
establish a plurality of virtual connections from an input component to multiple output components, wherein the input component is the master component or one of the active slave components.

29. The entertainment network of claim 24 further comprises:
the channel including at least one of a wired communication channel and a wireless communication channel; and
each of the virtual connections including at least one of the wired communication channel and the wireless communication channel.

30. The entertainment network of claim 29 further comprises:
the wired communication channel including at least one of an Ethernet channel, a fire wire channel, and a standardized wired network protocol channel; and
the wireless communication channel including at least one of a Bluetooth wireless channel, an IEEE 802.11x wireless communication channel and a standardized wireless network protocol channel.

31. An entertainment network comprises:
a master component that includes a master processing module and master memory; and
a plurality of slave components, wherein each of the plurality of slave components includes a slave processing module and slave memory, wherein the master memory and the slave memory store operational instructions that cause the master processing module and the slave processing module to, respectively, enable the master component and the plurality of slave components to:
sense, by the master component, activation of one of a plurality of components of the entertainment network, wherein the plurality of components includes the master component and the plurality of slave components;
determine, by the master component, configuration requirements for the one of the plurality of components;
provide, by the master component, an enable signal to another one of the plurality of components when the configuration requirements include interfacing with the another one of the plurality of components;
assign, by the master component, at least one channel to support network-type communications involving the one of the plurality of components; and
allocate, by the master component, bandwidth of the at least one channel to the one of the plurality of components for up-stream communications.

32. The entertainment network of claim 31, wherein the master memory further store operational instructions that cause the master processing module to enable the master component to:
allocate, by the master component, additional bandwidth of the at least one channel to the another one of the plurality of components for down-stream communications.

33. The entertainment network of claim 31, wherein the master memory and the slave memory further store operational instructions that cause the master processing module and slave processing module to enable the master component and each of the plurality of slave components, respectively, to sense the activation by:
receiving, by the one of the plurality of components, a user input; and
providing, by the one of the plurality of components, an activation signal to the master component, wherein the activation signal indicates at least one function to be performed by the one of the plurality of components.

34. The entertainment network of claim 33, wherein the master memory further store operational instructions that cause the master processing module to enable the master component to determine the configuration requirements by:
interpreting the activation signal to identify the another one of the plurality of components and to determine bandwidth requirements.

35. The entertainment network of claim 34, wherein the master memory further store operational instructions that cause the master processing module to enable the master component to determine the configuration requirements by:
accessing configuration preferences table for the one of the plurality of components to determine configuration preferences;
accessing a virtual connection map based on the configuration preferences to determine virtual connections; and
determining number of channels to be established and the bandwidth requirements of each of the wireless channels based on virtual connections and the configuration preferences.

36. The entertainment network of claim 35 further comprises:
the channel including at least one of a wired communication channel and a wireless communication channel; and
each of the virtual connections including at least one of the wired communication channel and the wireless communication channel.

37. The entertainment network of claim 36 further comprises:
the wired communication channel including at least one of an Ethernet channel, a fire wire channel, and a standardized wired network protocol channel; and
the wireless communication channel including at least one of a Bluetooth wireless channel, an IEEE 802.11x wireless communication channel and a standardized wireless network protocol channel.

38. An entertainment network comprises:
a master component that includes a master processing module and master memory; and
a plurality of slave components, wherein each of the plurality of slave components includes a slave processing module and slave memory, wherein the master memory and the slave memory store operational instructions that cause the master processing module and the slave processing module to, respectively, enable the master component and the plurality of slave components to:
place the entertainment network in a configuration mode;
provide a user interface within the entertainment network to receive user configuration commands;
interpret, by the master component, the user configuration commands to determine desired connections within the entertainment network;
determine, by the master component, bandwidth requirements for each of the desired connections; and
based on the bandwidth requirements for each of the desired connections, establish, by the master component, at least one of:
a virtual connection between the master component and one of a plurality of slave components of the entertainment network; and
a virtual connection between a first one of the plurality of slave components and a second one of the plurality of slave components.

39. The entertainment network of claim 38, wherein the master memory further store operational instructions that cause the master processing module to enable the master component to:
monitor operational status of the plurality of slave components for an operational change.

40. The entertainment network of claim 38, wherein the master memory further store operational instructions that cause the master processing module to enable the master component to provide the user interface by at least one of:
providing a list of input components of the entertainment network;
providing a list of output components of the entertainment network;
detecting desired connections of one of the input components to at least one of the output components to establish a selected connection; and
detecting desired function of the selected connection to produce a selected function.

41. The entertainment network of claim 40, wherein the master memory further store operational instructions that cause the master processing module to enable the master component to the determine the bandwidth requirements by:
determining the bandwidth requirements for the selected connection based on the selected function.

42. The entertainment network of claim 38 further comprises:
each of the virtual connections including at least one of the wired communication channel and the wireless communication channel.

43. The entertainment network of claim 42 further comprises:
the wired communication channel including at least one of an Ethernet channel, a fire wire channel, and a standardized wired network protocol channel; and
the wireless communication channel including at least one of a Bluetooth wireless channel, an IEEE 802.11x wireless communication channel and a standardized wireless network protocol channel.
